(19) United States
(12) Patent Application Publication
(10) Pub. No.: US 2026/0097788 A1
(43) Pub. Date: Apr. 9, 2026

(54) Method and System for Determining a Stopping Location and Trajectory for Reducing a Steering Angle

(71) Applicant: Bayerische Motoren Werke Aktiengesellschaft, Muenchen (DE)

(72) Inventors: Matthias Fischer, Rohrbach (DE); Jakob Huemer, Muenchen (DE); Patrick Sauermann, Augsburg (DE); Andreas Spaeth, Lindau (DE)

(21) Appl. No.: 19/350,140

(22) Filed: Oct. 6, 2025

(30) Foreign Application Priority Data
Oct. 7, 2024 (DE) 10 2024 128 835.3

(51) Int. Cl. B60W 60/00; B60W 30/18

(52) U.S. Cl. CPC B60W 60/001; B60W 30/181; B60W 2510/20; B60W 2520/10; B60W 2710/207

(57) ABSTRACT

A method for a driving automation system function for a motor vehicle includes capturing driving maneuver information; determining, on the basis of the driving maneuver information, a planned trajectory with a stopping location, at which the motor vehicle comes to a standstill according to the planned trajectory, wherein the planned trajectory with the stopping location describes a curvature; determining, on the basis of the curvature, a steering angle related to the stopping location; determining, on the basis of the steering angle, an adjusted trajectory with a reduced target steering angle compared to the steering angle; and outputting a control signal for controlling the driving automation system function to follow the adjusted trajectory.

### CROSS REFERENCE TO RELATED APPLICATION

This application claims priority under 35 U.S.C. §119 from German Patent Application No. DE 102024128 835.3, filed October 7, 2024, the entire disclosure of which is herein expressly incorporated by reference.

### BACKGROUND AND SUMMARY

The present disclosure relates to a method for a driving automation system function for a motor vehicle. The disclosure also relates to a computer program and/or computer-readable medium, a data processing apparatus and a motor vehicle.

Such driving automation system functions ("Driving Automation System Feature", see SAE International standard J3016) are known from the prior art and offer longitudinal and/or lateral guidance. Such driving automation system functions can implement any level of the driving automation taxonomy according to standard J3016.

It is known that a trajectory of the motor vehicle is planned and/or regulated on the basis of the course of the route, for example an intersection geometry, a course of a lane and/or other road users.

For the controllability of the motor vehicle and driving comfort, it is important that the steering wheel angle is zero, for example when driving in a straight line or when the wheels are in a straight-ahead position, that is to say the steering wheel has a deflection of zero. Therefore, some methods for setting or adjusting the steering wheel angle are known from the prior art.

DE 10345303 A1 discloses a determination of the difference between the wheel speeds of the left-hand wheels and those of the right-hand wheels; correction of the previously current delta steering wheel angle, which indicates the difference between the actual steering wheel angle when driving straight ahead and a fixed reference value of the steering wheel angle, to form the new delta steering wheel angle if the difference is equal to zero during a predefinable first period of time within the framework of a first predefinable tolerance value; regulation of the dynamic cornering light based on the current delta steering wheel angle.

The steering wheel angle can change due to the intervention of an automated or autonomous driving function. Lateral guidance can trigger a steering process in which the steering angle, i.e. the steering wheel angle and/or an angle defined by the wheels in relation to a straight-ahead position, changes. In the case of longitudinal/lateral guidance by the driving automation system function, for example in a turning situation, due to a required stopping position and/or stopping zone, in particular in intersection situations according to the planned trajectory, standstill situations with a steering wheel misalignment can occur, that is to say a position of the steering wheel and accordingly of the wheels with a deflection present relative to a straight-ahead position or a steering wheel angle not equal to zero. However, the steering wheel misalignments or the deflection can reduce the controllability of the motor vehicle. For example, a user wishing to take over the control of the motor vehicle must first search for the input elements and/or user interfaces arbitrarily arranged by the steering wheel angle in order to take over the driving function by an input on operating elements on the steering wheel. In addition, from the user's point of view, the steering wheel misalignments can possibly be perceived as uncomfortable and can thus impair the driving comfort.

Against the background of this prior art, an object of the present disclosure is to specify an apparatus and a method which are each suitable for enhancing the prior art and at least improving the above-mentioned aspects of the prior art. In particular, the object of the disclosure is to reduce and/or avoid an impairment of the controllability of the driving automation system function or the motor vehicle as well as the driving comfort.

The object is achieved by the features of the independent claims. The dependent claims contain developments of the disclosure.

Accordingly, the object is achieved according to one aspect of the disclosure by a method for a driving automation system function for a motor vehicle; wherein the method comprises: capturing driving maneuver information; determining, on the basis of the driving maneuver information, a planned trajectory with a stopping location, at which the motor vehicle comes to a standstill according to the planned trajectory, wherein the planned trajectory with the stopping location describes a curvature; determining, on the basis of the curvature, a steering angle related to the stopping location; determining, on the basis of the steering angle, an adjusted trajectory with a reduced target steering angle compared to the steering angle; and outputting a control signal for controlling the driving automation system function to follow the adjusted trajectory.

It was recognized that a steering angle or a steering wheel position as a regulation goal or as information influencing the driving automation system function has previously not been taken into account in the prior art. It is therefore proposed to determine a planned trajectory with the stopping location, and to define, by means of the adjusted trajectory, an adjustment of the trajectory to be driven compared to the planned trajectory, which is dependent on the steering angle at the stopping location. This allows the steering angle at the stopping location to be included in the control of the motor vehicle by the driving automation system function. It is thus possible to achieve the situation in which it is possible to adjust the trajectory in order to achieve a target steering angle that is smaller than the steering angle along the planned trajectory.

In the case of longitudinally and/or laterally guided driving assisted by the driving automation system function, particularly in the case of low curve radii and/or a turning situation, higher steering wheel angles in a stopping position and/or the stopping position can be avoided and thus the controllability and driving comfort of the driver assistance can be improved. It can be advantageous if the steering wheel angle is as small as possible and/or zero when stationary, for example when stopped. This makes it possible to ensure that a user of the motor vehicle can quickly and effectively find operating elements and/or user interfaces arranged, for example, on and/or at the steering wheel, without having to search for them due to a comparatively large steering wheel angle.

Optionally, the determination of the adjusted trajectory and/or the output of the control signal is/are carried out taking into account a threshold condition relating to the steering angle and defined by a limit steering angle. It was recognized that the determination of the adjusted trajectory and/or the output of the control signal for changing the trajectory can be dispensable if the steering angle is comparatively small, i.e. smaller than the limit steering angle. The limit steering angle can indicate a steering angle that can be tolerated by a user at the stopping location. This allows more effective use of resources of the driving automation system function. If the steering angle is comparatively large, i.e. larger than the limit steering angle, the determination of the adjusted trajectory and/or the output of the control signal can be carried out in order to avoid the steering angle at the stopping location.

Optionally, the adjusted trajectory is determined such that the target steering angle falls below an acceptance steering angle when stationary and/or when a speed of the motor vehicle is less than a minimum speed. It was recognized that achieving an acceptance steering angle which is smaller than the limit steering angle can be sufficient to reduce and/or avoid impairment of the controllability of the driving automation system function or the motor vehicle as well as the driving comfort. The acceptance steering angle can indicate a steering angle that is perceived by a user as comfortable and/or that ensures effective and reliable controllability. The acceptance steering angle can be greater than zero. For example, the acceptance steering angle is less than 45°, in particular less than 30°, more particularly less than 22.5° or less than 12.5°. As the acceptance steering angle decreases, greater adjustment of the trajectory may be necessary, but the comfort and/or controllability may increase. The method can be used with regard to low speeds, i.e. at speeds lower than the minimum speed, and/or with regard to a standstill.

Optionally, the planned trajectory comprises an expected standstill time relating to the standstill at the stopping location and/or a period of a low speed of the motor vehicle less than a minimum speed in an environment of the stopping location; and the determination of the adjusted trajectory takes place on the basis of the standstill time and/or the period. It was recognized that the determination of the adjusted trajectory, in addition to the steering angle at the stopping location, can depend on the standstill time and/or the period. It was recognized that a larger steering angle can be tolerable over a shorter standstill time, whereas a smaller steering angle can be tolerable over a longer standstill time. A standstill time at the stopping location and the associated tolerable steering angle at the stopping location, for example the limit steering angle, can be retrieved from a characteristic map or a table. It was also recognised that a standstill, i.e. a speed of zero, is not necessary. The method can also be used at low speeds, i.e. at speeds lower than the minimum speed.

Optionally, the adjusted trajectory comprises a target stopping location, and the target stopping location is not identical to or is identical to the stopping location. With the target stopping location, it is possible to plan an adjusted trajectory which also provides for a standstill of the motor vehicle, for example at an intersection and/or at a traffic light. The target stopping location may not be identical to the stopping location, for example in order to avoid large curvatures and thus larger steering angles. However, it may also be possible for the target stopping location to be identical to the stopping location, and for the adjusted trajectory to define an approach to the destination stopping location or stopping location that is adjusted compared to the planned trajectory. Alternatively, the adjusted trajectory avoids a standstill of the motor vehicle. It was recognized that, with the adjusted trajectory, standstill need not be necessary and/or proves to be unnecessary or no longer necessary due to other circumstances, such as traffic lights and/or other road users.

Optionally, the control signal causes the steering wheel angle to be influenced before, during and/or after the stopping of the motor vehicle. This allows the steering angle to be adjusted to a smaller steering angle when stationary, in the stopping process and/or in the starting process, and allows re-steering before starting or stronger steering in the event of re-starting in order to realize the trajectory.

Optionally, the determination of the adjusted trajectory with the target steering angle is carried out on the basis of a stopping period that characterizes holding of the target steering angle. It was recognized that the determination of the adjusted trajectory, in addition to the steering angle at the stopping location, can depend on the target steering angle and the stopping period. It was recognized that a larger target steering angle can be tolerable over a shorter stopping period, whereas a smaller target steering angle can be tolerable over a longer stopping period. A stopping period and the associated tolerable target steering angle, for example the acceptance steering angle, can be retrieved from a characteristic map or a table.

According to one aspect of the disclosure, a computer program and/or a computer-readable medium is/are provided. The computer program and/or the computer-readable medium comprise(s) instructions which, when the program or the instructions is/are executed by a data processing apparatus, cause the latter to carry out the method according to the disclosure and/or steps thereof. Optionally, the computer program and/or the computer-readable medium comprise(s) instructions which, when the program or the instructions is/are executed by a data processing apparatus, cause the latter to carry out the method steps described as advantageous or optional in order to achieve an associated technical effect.

According to one aspect of the disclosure, a data processing apparatus for a motor vehicle is provided. The data processing apparatus is configured to carry out the method according to the disclosure. Optionally, the data processing apparatus is configured to carry out a method step described as advantageous or optional and/or to implement a method feature in order to achieve an associated technical effect.

According to one aspect of the disclosure, a motor vehicle comprising a driving automation system function and the data processing apparatus according to the disclosure is provided. Optionally, the data processing apparatus of the motor vehicle and/or the motor vehicle is/are configured to carry out a method step described as advantageous or optional and/or to implement a method feature in order to achieve an associated technical effect.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 schematically shows a motor vehicle according to one aspect of the disclosure;

FIG. 2 schematically shows a flowchart of a method according to one aspect of the disclosure;

FIG. 3 shows a schematic representation of a computer program and/or computer-readable medium according to one aspect of the disclosure;

FIG. 4 shows an example of a motor vehicle when carrying out the method according to one aspect of the disclosure;

FIG. 5 shows an example of a motor vehicle when carrying out the method according to one aspect of the disclosure; and

FIG. 6 schematically shows three examples of a steering angle when carrying out the method according to one aspect of the disclosure.

### DETAILED DESCRIPTION OF THE DRAWINGS

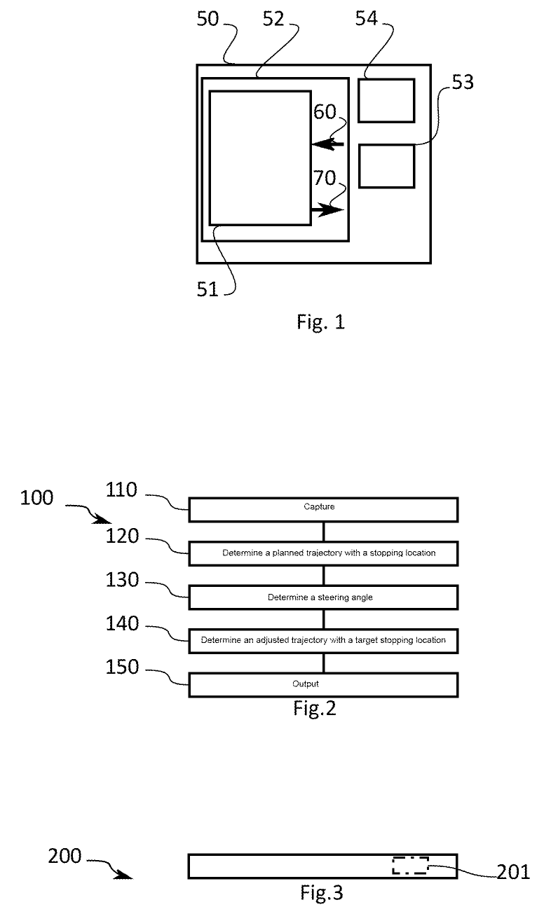

FIG. 1 schematically shows a motor vehicle 50 according to one aspect of the disclosure. The motor vehicle 50 is a land vehicle. The motor vehicle 50 is an automobile.

The motor vehicle 50 comprises a driving automation system function 52. The driving automation system function 52 comprises a data processing apparatus 51. The data processing apparatus 51, the driving automation system function 52 and the motor vehicle 50 are respectively configured to carry out the method 100 described with reference to FIG. 2. For this purpose, the motor vehicle 50 according to FIG. 1 has a sensor apparatus 53 and a communication interface 54. In another embodiment (not shown), the sensor apparatus 53 and/or the communication interface 54 may be included in the driving automation system function 52.

The sensor apparatus 53 comprises an environmental sensor system for capturing sensor data which relate to the environment of the motor vehicle 50 and are transmitted as driving maneuver information 60 to the driving automation system function 52 and/or the data processing apparatus 51 for further processing. The sensor apparatus 53 comprises, for example, a radar apparatus, a lidar apparatus and/or a camera. The sensor apparatus 53 and the data processing apparatus 51 are connected to each other using communication technology, so that the driving maneuver information 60 can be transmitted to the data processing apparatus 51. The driving maneuver information 60 relates to information that can be used to carry out an automated driving function, in particular longitudinal and/or lateral guidance, by means of the driving automation system function 52.

The communication interface 54 is configured to communicate wirelessly with a further motor vehicle (not shown), for example by means of vehicle-to-vehicle communication (V2V), a server outside the vehicle or the backend and/or the cloud and/or an infrastructure element, for example by means of vehicle-to-infrastructure communication (V2I). For this purpose, the communication interface 54 is set up, for example, for communication over a wireless local area network (WLAN) and/or over a mobile radio network. The communication interface 54 and the data processing apparatus 51 are connected to each other using communication technology for the purpose of transmitting information or data as driving maneuver information 60 to the driving automation system function 52 and/or the data processing apparatus 51 for further processing. In addition, the motor vehicle 50 can be located using a global navigation satellite system (GNSS) for lane-accurate positioning of the motor vehicle 50.

The data processing apparatus 51 is configured to capture and process the driving maneuver information 60. The driving maneuver information 60 includes, for example, map information, environmental information and information related to the motor vehicle 50. The driving maneuver information 60 is used to predict a driving maneuver, for example with a small curve radius, e.g. turning.

The data processing apparatus 51 is configured to determine a planned trajectory 61 with a stopping location 62, at which the motor vehicle 50 comes to a standstill according to the planned trajectory 61, based on the driving maneuver information 60. In this case, the planned trajectory 61 with the stopping location 62 describes a curvature 63, or the planned trajectory 61 comprises a curve that runs through the stopping location 62, begins at the stopping location 62 and/or ends at the stopping location 62. The planned trajectory 61 and generally a trajectory can describe the motor vehicle 50 on a path and optionally at a speed depending on a time.

Since the planned trajectory 61 comprises the stopping location 62, a stopping point of the motor vehicle 50 during the planned driving maneuver along the planned trajectory 61 is also predicted. The need for a deceleration to the standstill along the planned trajectory 61 is predicted from map and/or environmental sensor system information. Necessary stopping of the motor vehicle 50 can be predicted by the data processing apparatus 51 by means of different detected boundary conditions: a) route conditions and/or a course of a route, such as an intersection situation and/or a traffic circle; b) traffic signs, such as a stop sign, a give way sign, a sign indicating a bending main road; c) signaling systems, if necessary with knowledge of a traffic light signal color and/or barriers; d) situational, market-specific priority rules such as priority for oncoming traffic when turning left; e) acceleration, driving, deceleration, stopping and/or standstill of other road users 40 e.g. deceleration to the standstill of another road user 40 ahead when turning left. The data processing apparatus 51 is configured to predict the steering angle/steering wheel angle at the stopping location 62. For this purpose, it is possible to evaluate in particular the curvature 63 of the planned trajectory 61 in conjunction with the driving maneuver information 60. In this case, depending on the stopping position or the stopping location 62 along the planned trajectory 61 of the driving maneuver, the resulting steering angle 68 at the predicted stopping location 62 is determined.

The planned trajectory 61 comprises an expected standstill time 66 relating to the standstill at the stopping location 62. In other words, depending on the boundary conditions of the standstill, the expected standstill time 66 is estimated by the data processing apparatus 51.

The data processing apparatus 51 is configured to determine a steering angle 68 related to the stopping location 62 based on the curvature 63. Based on the curvature 63 and optionally the driving maneuver information 60, a trajectory is planned as a planned trajectory 61 by the driving automation system function 52, the curvature 63, i.e. curve radius, radius of curvature and/or curvature progression, of which determines a steering angle 68. The steering angle 68 can characterize the deflection of a steering wheel (not shown), that is to say the steering wheel angle, and/or of a wheel of the motor vehicle 50, in particular relative to a vehicle longitudinal axis. This makes it possible to infer the steering angle 68 at the stopping location 62.

The data processing apparatus 51 is configured to determine, on the basis of the steering angle 68, an adjusted trajectory 64 with a reduced target steering angle 69 compared to the steering angle 68. In other words, the data processing apparatus 51 evaluates the need to adjust the trajectory or the steering angle 68 at a standstill. The adjusted trajectory 64 is determined in such a way that the target steering angle 69 falls below an acceptance steering angle 68A. The acceptance steering angle 68A is smaller than the steering angle 68 at the stopping location 62.

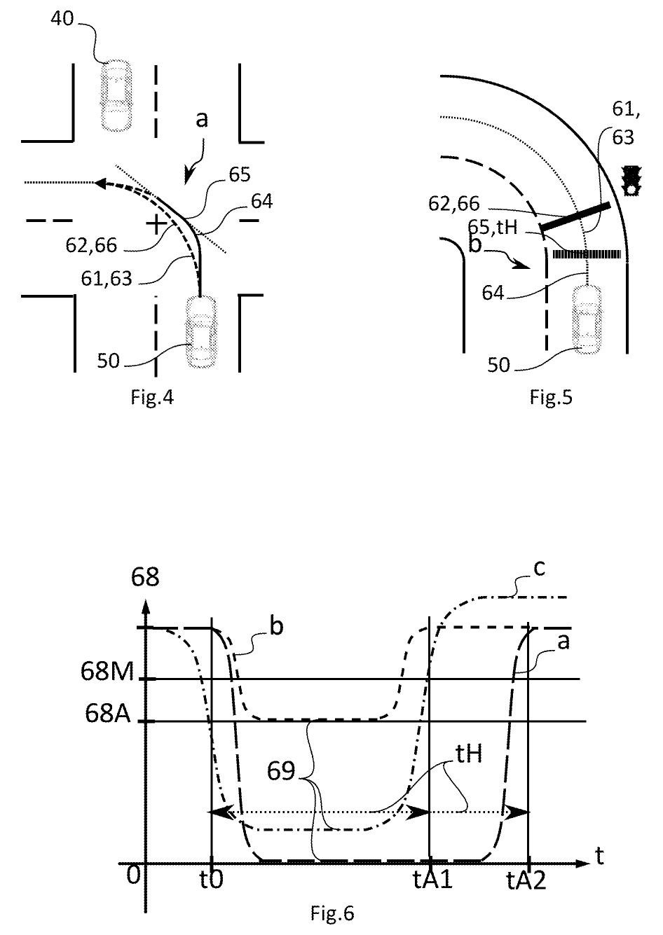

The adjusted trajectory 64 optionally comprises a target stopping location 65, and the target stopping location 65 is not identical to (see possibility for FIG. 4 and FIG. 5) or is identical to the stopping location 62. Alternatively, the adjusted trajectory 64 avoids a standstill of the motor vehicle 50 (see possibility for FIG. 4).

The determination of the adjusted trajectory 64 with the target steering angle 69 is carried out on the basis of a stopping period tH that characterizes holding of the target steering angle 69 (see FIG. 6). The adjusted trajectory 64 is determined on the basis of the standstill time 66 (see FIG. 5).

The data processing apparatus 51 is configured to output a control signal 70 for controlling the driving automation system function 52 taking into account the adjusted trajectory 64 and for following the adjusted trajectory 64. In this case, the driving of the motor vehicle 50 is set to driving along the adjusted trajectory 63. For this purpose, the control signal 70 can be output to another component of the driving automation system function 52. The control signal 70 causes the steering angle 68 to be influenced before, during and/or after the stopping of the motor vehicle 50.

The determination 140 of the adjusted trajectory 64 and/or the output 150 of the control signal 70 is/are carried out taking into account a threshold value condition relating to the steering angle 68 and defined by a limit steering angle 68M. In other words, the resulting steering angle 68 at the stopping location 62 and/or the target steering angle 69 in the predicted target stopping location 65 is/are compared with a maximum steering angle or the limit steering angle 68M. The determination 140 of the adjusted trajectory 64 and/or the output 150 of the control signal 70 is/are carried out if the steering angle 68 exceeds a limit steering angle 68M defined by the threshold value condition. Alternatively or additionally, the determination 140 of the adjusted trajectory 64 and/or the output 150 of the control signal 70 is/are not carried out if the steering angle 68 falls below the limit steering angle 68M defined by the threshold value condition.

Possible variants of an adjusted trajectory are determined based on the situational environmental conditions (e.g. other road users 40, objects, route conditions, geometry). The possibilities for adjustment also depend on the forecast time of the driver assistance for an upcoming stopping location 62 of the motor vehicle 50. This shall be illustrated with FIGS. 4 to 6 in three scenarios a, b and c.

Exemplary applications of the method 100 are described with reference to FIGS. 4 to 6.

FIG. 2 schematically shows a flowchart of a method 100 according to one aspect of the disclosure. The method 100 according to FIG. 2 is a method 100 for a driving automation system function 52 for a motor vehicle 50. Such a driving automation system function 52 and such a motor vehicle 50 are each described with reference to FIG. 1. FIG. 2 is described with reference to FIG. 1.

The method 100 comprises: capturing 110 driving maneuver information 60.

The method 100 comprises: determining 120, on the basis of the driving maneuver information 60, a planned trajectory 61 with a stopping location 62, at which the motor vehicle 50 comes to a standstill according to the planned trajectory 61, wherein the planned trajectory 61 with the stopping location 62 describes a curvature 63. The planned trajectory 61 comprises an expected standstill time 66 relating to the standstill at the stopping location 62 and/or a period of a low speed of the motor vehicle 50 less than a minimum speed in an environment of the stopping location 62.

The method 100 comprises: determining 130, on the basis of the curvature 63, a steering angle 68 related to the stopping location 62.

The method 100 comprises: determining 140, on the basis of the steering angle 68, an adjusted trajectory 64 with a reduced target steering angle 69 compared to the steering angle 68. The adjusted trajectory 64 is determined such that the target steering angle 69 falls below an acceptance steering angle 68A when stationary and/or when a speed of the motor vehicle 50 is less than a minimum speed. The adjusted trajectory 64 optionally comprises a target stopping location 65, and the target stopping location 65 is not identical to or is identical to the stopping location 62. Alternatively, the adjusted trajectory 64 avoids a standstill of the motor vehicle 50. The determination 140 of the adjusted trajectory 64 with the target steering angle 69 is carried out on the basis of a stopping period tH that characterizes holding of the target steering angle 69. The determination 140 of the adjusted trajectory 64 takes place on the basis of the standstill time 66 and/or the period.

The method 100 comprises: outputting 150 a control signal 70 for controlling the driving automation system function 52 to follow the adjusted trajectory 64. The control signal 70 causes the steering wheel angle 68 to be influenced before, during and/or after the stopping of the motor vehicle 50.

The determination 140 of the adjusted trajectory 64 and/or the output 150 of the control signal 70 is/are carried out taking into account a threshold value condition relating to the steering angle 68 and defined by a limit steering angle 68M. The determination 140 of the adjusted trajectory 64 and/or the output 150 of the control signal 70 is/are carried out if the steering angle 68 exceeds a limit steering angle 68M defined by the threshold value condition. Alternatively or additionally, the determination 140 of the adjusted trajectory 64 and/or the output 150 of the control signal 70 is/are not carried out if the steering angle 68 falls below the limit steering angle 68M defined by the threshold value condition.

In this case, a person skilled in the art recognizes that the method 100 according to FIG. 2 can also be carried out in a sequence other than that shown. In particular, it is possible for steps of the method 100 to be able to be swapped, shifted, repeated and/or carried out simultaneously.

FIG. 3 shows a schematic representation of a computer program and/or computer-readable medium 200 according to one aspect of the disclosure. The computer program and/or computer-readable medium 200 comprise(s) instructions 201 which, when the program or the instructions 201 is/are executed by a data processing apparatus 51, cause the latter to carry out the method 100 and/or the steps of the method 100 according to FIG. 2.

The instructions 201 may be present as a program code in any code or in any language, in particular in a code suitable for controlling and/or monitoring motor vehicles 50 and/or their driving automation system functions 52. The computer program and/or computer-readable medium 200 may be or comprise any digital data storage device, such as a USB stick, a hard disk, a CD-ROM, an SD card, or an SSD card. The computer program does not necessarily have to be stored on such a computer-readable storage medium, but may also be retrieved via the Internet or otherwise.

FIG. 4 shows an example of a motor vehicle 50 when carrying out the method 100 according to one aspect of the disclosure. The motor vehicle 50 according to FIG. 4 is the motor vehicle 50 described with reference to FIG. 1 and the method 100 is the method 100 described with reference to FIG. 2. FIG. 4 is described with reference to FIGS. 1 to 3.

FIG. 4 illustrates a first scenario a with an adjustment of the trajectory of the longitudinal and/or lateral guidance and thus a steering angle progression with a reduction in the steering angle 68 in the region of the stopping location 63. In this case, the motor vehicle 50 or ego vehicle drives toward an intersection. A planned trajectory 61 provides for a left turn. A further road user 40 approaches the motor vehicle 50. The planned trajectory 61 therefore provides a stopping location 62 with a predicted standstill time 66 in order to give priority to the further road user 40. An assisted longitudinally and/or laterally guided left turn is implemented on the basis of a navigation route. The planned trajectory 61 is determined from the environmental sensor system, localization and map information as driving maneuver information 60. The stopping location 62 in the middle of the intersection is predicted from map information and knowledge of priority rules. Due to the curvature 63, which is also not equal to zero at the stopping location 62, the steering angle 68 is produced at a standstill in the middle of the intersection. Based on the environmental sensor system, map information and/or positioning as driving maneuver information 60, the possibility of an alternative target trajectory or the adjusted trajectory 64 is tested with the aim of reducing and/or avoiding the steering angle when stationary. An adjusted trajectory 64 is calculated. By outputting the control signal 70, the driving automation system function 52 is regulated and/or controlled according to the modified trajectory 64. The adjusted trajectory 64 may have a target stopping point 65 at which the target steering angle 69 is equal to zero, since the curvature 63 at the target stopping point 65 is zero (see schematically the tangent to the adjusted trajectory 64). When approaching the target stopping point 65, it may emerge that a standstill is not necessary, for example due to acceleration of the further road user 40 and/or a slow approach to the target stopping point 65, thus making it possible to avoid a standstill of the motor vehicle 50.

FIG. 5 shows an example of a motor vehicle 50 when carrying out the method 100 according to one aspect of the disclosure. The motor vehicle 50 according to FIG. 5 is the motor vehicle 50 described with reference to FIG. 1 and the method 100 is the method 100 described with reference to FIG. 2. FIG. 5 is described with reference to FIGS. 1 to 4.

FIG. 5 illustrates a second scenario b for adjusting the stopping position along the trajectory, for example advancing the stopping position to a point along the planned trajectory 61 with a lower curvature 63 and thus with a smaller steering angle 68.

Example 2: Longitudinal/lateral left turn with a stopping point at the intersection for giving way (FIG. 2): The motor vehicle 50 drives with longitudinal and/or lateral guidance toward a curve near a traffic light. Due to the environmental sensor system as driving maneuver information 60, a switch of the traffic light to red is detected. Based on back-end data, the switching cycle of the traffic light is known and a standstill time 66 of 1 minute is estimated by the driving automation system function 52. A steering angle 68 is determined on the basis of the curve radius/progression of the radius of curvature of the planned trajectory 61. Due to the curvature 63 of the planned trajectory 61 and the predicted stopping location 62 in front of the red traffic light, a steering angle 68 at a standstill at the stopping location 62 is predicted. The need to adjust the trajectory is assessed by way of a comparison with a limit steering angle 68M when stationary. The possibility of an adjusted trajectory 64 with a target stopping location 65 is tested from the environmental sensor system, map information and/or positioning as driving maneuver information 60 with the aim of reducing the steering angle 68 when stationary. The target stopping location 65 is calculated as an alternative stopping position and the distance to the previously determined stopping position is evaluated. By outputting the control signal 70, the driving automation system function 52 is regulated and/or controlled according to the modified trajectory 64.

FIG. 6 schematically shows three examples of a steering angle 68 when carrying out the method 100 according to one aspect of the disclosure. The method 100 is the method 100 described with reference to FIG. 2. FIG. 6 is described with reference to FIGS. 1 to 5.

FIG. 6 illustrates the steering angle 68 as a function of the time t in the scenarios a, b, c.

There is a stopping time t0 at which the motor vehicle 50 reaches the target stopping position 65 and comes to a standstill there. In the scenarios a, b, c, the target steering angle 69, which is established at a standstill, is less than the limit steering angle 68M and less than or equal to the acceptance steering angle 68A. In the first scenario a, the steering angle 68 is reduced to a target steering angle 69 of zero as described. The target steering angle 69 is held in each case for a stopping period tH up to a first approach time tA1 or a second approach time tA2.

The third scenario c is an adjustment of the steering angle 68 when stationary, during a stopping process and/or during a starting process. The motor vehicle 50 drives with longitudinal and/or lateral guidance in a curve with another road user 40 as a vehicle in front, e.g. in a traffic circle, a freeway entrance ramp. Due to abrupt braking of the other road user 40, the motor vehicle 50 is decelerated to a standstill in the curve by the driving automation system function 52. At a standstill, a steering wheel angle 68 exceeding the limit steering angle 68M would result on the basis of the planned trajectory 61. An adjusted trajectory 64 is determined by adjusting the steering angle 68 to a smaller steering angle 68 when stationary, during a stopping process and/or during a starting process and there is re-steering before starting or stronger steering in the event of re-starting in order to realize the previous planned trajectory 64.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

### Reference signs

40 Other road user

50 Motor vehicle, ego vehicle

51 Data processing apparatus

52 Driving automation system function

53 Sensor apparatus

54 Communication interface

60 Driving maneuver information

61 Planned trajectory

62 Stopping location

63 Curvature

64 Adjusted trajectory

65 Target stopping location

66 Standstill time

68 Steering angle

68A Acceptance steering angle

68M Limit steering angle

69 Target steering angle

70 Control signal

100 Method

110 Capture

120 Determine a planned trajectory with a stopping location

130 Determine a steering angle

140 Determine an adjusted trajectory with a target stopping location

150 Output

200 Computer program and/or computer-readable medium

201 Instructions

A First scenario

B Second scenario

C Third scenario

T Time

t0 Stopping time

tA1 First approach time

tA2 Second approach time

tH Stopping period

What is claimed is:

1. A method for a driving automation system function for a motor vehicle, the method comprising:
capturing driving maneuver information;
determining, based on the driving maneuver information, a planned trajectory with a stopping location, at which the motor vehicle comes to a standstill according to the planned trajectory, wherein the planned trajectory with the stopping location describes a curvature;
determining, based on the curvature, a steering angle related to the stopping location;
determining, based on the steering angle, an adjusted trajectory with a reduced target steering angle compared to the steering angle; and
outputting a control signal for controlling the driving automation system function to follow the adjusted trajectory.

2. The method according to claim 1, wherein
the determination of the adjusted trajectory and/or the outputting of the control signal is/are carried out taking into account a threshold condition relating to the steering angle and defined by a limit steering angle.

3. The method according to claim 1, wherein
the adjusted trajectory is determined such that the target steering angle falls below an acceptance steering angle when stationary and/or when a speed of the motor vehicle is less than a minimum speed.

4. The method according to claim 1, wherein
the planned trajectory comprises an expected standstill time relating to the standstill at the stopping location and/or a period of a low speed of the motor vehicle less than a minimum speed in an environment of the stopping location; and
the determination of the adjusted trajectory takes place based on the standstill time and/or the period.

5. The method according to claim 1, wherein
the adjusted trajectory comprises a target stopping location, and the target stopping location is not identical to or is identical to the stopping location; or
the adjusted trajectory avoids a standstill of the motor vehicle.

6. The method according to claim 1, wherein
the control signal causes the steering wheel angle to be influenced before, during and/or after the stopping of the motor vehicle.

7. The method according to claim 1, wherein
the determination of the adjusted trajectory with the target steering angle is carried out based on a stopping period that characterizes holding of the target steering angle.

8. A computer product comprising a non-transitory computer-readable medium having program code stored thereon which, when executed by a data processing apparatus, causes the data processing apparatus to carry out the acts of:
capturing driving maneuver information;
determining, based on the driving maneuver information, a planned trajectory with a stopping location, at which the motor vehicle comes to a standstill according to the planned trajectory, wherein the planned trajectory with the stopping location describes a curvature;
determining, based on the curvature, a steering angle related to the stopping location;
determining, based on the steering angle, an adjusted trajectory with a reduced target steering angle compared to the steering angle; and
outputting a control signal for controlling the driving automation system function to follow the adjusted trajectory.

9. A data processing apparatus for a motor vehicle, comprising:
a processor and associated memory configured to carry out the acts of:
capturing driving maneuver information;
determining, based on the driving maneuver information, a planned trajectory with a stopping location, at which the motor vehicle comes to a standstill according to the planned trajectory, wherein the planned trajectory with the stopping location describes a curvature;
determining, based on the curvature, a steering angle related to the stopping location;
determining, based on the steering angle, an adjusted trajectory with a reduced target steering angle compared to the steering angle; and
outputting a control signal for controlling a driving automation system function to follow the adjusted trajectory.

10. A motor vehicle, comprising:
a driving automation system function; and
the data processing apparatus according to claim 9.
